(19) United States
(12) Patent Application Publication
(10) Pub. No.: US 2013/0170099 A1
(43) Pub. Date: Jul. 4, 2013

(54) ELECTRODE OF ENERGY STORAGE AND METHOD FOR MANUFACTURING THE SAME

(71) Applicant: Samsung Electro-Mechanics Co., Ltd., Suwon-si (KR)

(72) Inventors: Sang Kyun LEE, Suwon-si (KR); Seung Min KIM, Seoul (KR); Bae Kyun KIM, Seongnam-si (KR)

(73) Assignee: SAMSUNG ELECTRO-MECHANICS CO., LTD., Suwon-si (KR)

(21) Appl. No.: 13/730,723

(22) Filed: Dec. 28, 2012

(30) Foreign Application Priority Data
Dec. 28, 2011 (KR) 10-2011-0144815

(51) Int. Cl. H01G 9/042

(52) U.S. Cl. CPC H01G 9/042
USPC 361/502; 427/80

(57) ABSTRACT

Disclosed herein are an electrode of an energy storage and a method for manufacturing the same. The electrode includes: a current collector; a first electrode layer provided on one surface or both surfaces of the current collector; and a second electrode layer bonded to an outer surface of the first electrode layer, wherein in each of the first and second electrode layers, content ratios of an active material, a conductive material, and a binder, and materials thereof are different. Therefore, reliability of the energy storage may be increased and resistance thereof may be decreased.

### CROSS REFERENCE(S) TO RELATED APPLICATIONS

This application claims the benefit under 35 U.S.C. Section 119 of Korean Patent Application Serial No. 10-2011-0144815, entitled “Electrode of Energy Storage and Method for Manufacturing the Same” filed on Dec. 28, 2011, which is hereby incorporated by reference in its entirety into this application.

### BACKGROUND OF THE INVENTION

1. Technical Field

The present invention relates to an electrode of an energy storage and a method for manufacturing the same.

2. Description of the Related Art

A stable supply of energy has become important in various electronic products. Particularly, a role of stably supplying energy to a mobile electronic product has been mainly performed by a battery, and utilization of a secondary battery capable of being repeatedly charged and discharged has continuously increased.

Meanwhile, research into an electrochemical capacitor capable of supplying electrical energy while being repeatedly charged and discharged, similar to the secondary battery, has been continuously conducted.

Generally, the electrochemical capacitor has a very short charging and discharging time, a long lifespan, and very high output density as compared to the secondary battery, but has low energy density, such that it has a limitation in being used instead of the secondary battery.

However, the use of the electrochemical capacitor has gradually increased in fields such as regenerative braking of a vehicle, storage of wind power generation, and the like, to which advantages of the electrochemical capacitor such as a short charging and discharging time, a very high output density, or the like, may be applied. In addition, an effort to improve energy density has been continuously conducted.

Meanwhile, the electrochemical capacitor may be divided into a pseudocapacitor and an electric double layer capacitor (EDLC).

The pseudocapacitor uses a metal oxide as an electrode active material. A capacitor using the metal oxide has been continuously developed over about the pass twenty years.

The EDLC has currently used a porous carbon based material having high electrical conductivity, high thermal conductivity, low density, appropriate corrosion resistance, a low thermal expansion coefficient, and high purity as an electrode active material. Further, in order to improve performance of the EDLC, a number of researches into manufacturing of a new electrode active material for increasing a utilization ratio of the electrode active material and a cycle lifespan and improving high rate charging and discharging characteristics, surface reformation of the electrode active material, performance improvement of a separator and an electrolyte, performance improvement of an organic solvent electrolyte, and the like, have been conducted.

In most of electrochemical capacitors into which research has been currently conducted, a current collector made of an aluminum or titanium thin plate or an extended aluminum or titanium thin plate has been mainly used as current collectors of both electrodes. In addition, several types of current collectors such as an aluminum or titanium thin plate having a hole formed therein, and the like, has been used.

Meanwhile, when an activated carbon, which is an active material mainly used in order to implement capacitance in the electrochemical capacitor, is bonded to a surface of aluminum, or the like, which is a current collector, in the case in which a defect is present in a portion such as an air gap between activated carbon particles, a bonding portion between the current collector and the active material, or the like, resistance characteristics are significantly deteriorated.

FIG. 1 is a view schematically showing an electrode of an energy storage according to the related art.

Referring to FIG. 1, it may be easily understood that in the case in which an electrode material made of a porous carbon material contacts a surface of a current collector made of a metal such as aluminum, or the like, an air gap may be formed.

In order to solve this problem, Patent Document 1 has suggested a scheme in which an electrical conductive layer made of a conductive material and a binder is provided between a surface of a current collector and an electrode layer.

However, in this scheme, bonding strength is decreased due to heterogeneity between the electrical conductive layer and the electrode layer, such that resistance is increased or reliability is decreased.

FIG. 2 is a view schematically showing a general winding type energy storage according to the related art. Referring to FIG. 2, in the case of the winding type energy storage, due to heterogeneity revealed on an interface between an electrical conductive layer and an electrode layer as well as on an interface between a current collector and the electrical conductive layer and tension generated at the time of winding, a delamination phenomenon of the interface may be further intensified.

### SUMMARY OF THE INVENTION

An object of the present invention is to provide an electrode of an energy storage capable of increasing reliability and decreasing resistance through stable bonding between a current collector and an electrode layer, and a method for manufacturing the same.

According to an exemplary embodiment of the present invention, there is provided an electrode of an energy storage, the electrode including: a current collector; a first electrode layer provided on one surface or both surfaces of the current collector; and a second electrode layer bonded to an outer surface of the first electrode layer, wherein in each of the first and second electrode layers, content ratios of an active material, a conductive material, and a binder, and/or materials thereof are different.

The first electrode layer may contain: a first conductive material, which is at least one material selected from a group consisting of carbon black, acetylene black, CNT, CNF, ketjen black, and a first binder, which is at least one material selected from a group consisting of styrene-butadiene rubber (SBR), butadiene rubber, acrylic rubber, isoprene rubber, carboxylicmethylcellulose (CMC), and polyvinylpyrrolidone (PVP), and the second electrode layer may contain: a second active material, which is at least one carbon material selected from a group consisting of activated carbon, carbon nano-tube (CNT), graphite, carbon aerogel, polyacrylonitrile (PAN), carbon nano-fiber (CNF), activated carbon nano-fiber (ACNF), vapor grown carbon fiber (VGCF), and graphene, a second conductive material, which is at least one material selected from a group consisting of carbon black, acetylene black, CNT, CNF, ketjen black, and a second binder, which is at least one mixture of at least one material selected from a group consisting of styrene-butadiene rubber (SBR), butadiene rubber, acrylic rubber, isoprene rubber, and carboxylicmethylcellulose (CMC), and at least one material selected from a group consisting of polytetrafluoroethylene (PTFE), polyvinylidenefluoride (PVDF), and polyvinylformamide (PVFA).

In the first electrode layer, a weight ratio of the first conductive material to the first binder may be 60:40 to 65:35, and in the second electrode layer, a weight ratio of the second active material to the second conductive material to the second binder may be 88:5.5:6.5.

According to another exemplary embodiment of the present invention, there is provided an electrode of an energy storage, the electrode including: a current collector; a first electrode layer provided on one surface or both surfaces of the current collector and having a surface roughness formed on an outer surface thereof; and a second electrode layer bonded to the outer surface of the first electrode layer having the surface roughness, wherein in each of the first and second electrode layers, content ratios of an active material, a conductive material, and a binder, and materials thereof are different.

According to still another exemplary embodiment of the present invention, there is provided a method for manufacturing an electrode of an energy storage, the method including: applying first slurry to one surface or both surfaces of a current collector to form a first electrode layer; and applying second slurry to an outer surface of the first electrode layer to form a second electrode layer, wherein in each of the first and second electrode layers, content ratios of an active material, a conductive material, and a binder, and materials thereof are different.

The first slurry may contain: a first conductive material, which is at least one material selected from a group consisting of carbon black, acetylene black, CNT, CNF, ketjen black, and a first binder, which is at least one material selected from a group consisting of styrene-butadiene rubber (SBR), butadiene rubber, acrylic rubber, isoprene rubber, carboxylicmethylcellulose (CMC), and polyvinylpyrrolidone (PVP), and the second slurry may contain: a second active material, which is at least one carbon material selected from a group consisting of activated carbon, carbon nano-tube (CNT), graphite, carbon aerogel, polyacrylonitrile (PAN), carbon nano-fiber (CNF), activated carbon nano-fiber (ACNF), vapor grown carbon fiber (VGCF), and graphene, a second conductive material, which is at least one material selected from a group consisting of carbon black, acetylene black, CNT, CNF, ketjen black, and a second binder, which is at least one mixture of at least one material selected from a group consisting of styrene-butadiene rubber (SBR), butadiene rubber, acrylic rubber, isoprene rubber, and carboxylicmethylcellulose (CMC), and at least one material selected from a group consisting of polytetrafluoroethylene (PTFE), polyvinylidenefluoride (PVDF), and polyvinylformamide (PVFA).

In the first slurry, a weight ratio of the first conductive material to the first binder may be 60:40 to 65:35, and in the second slurry, a weight ratio of the second active material to the second conductive material to the second binder may be 88:5.5:6.5.

According to still another exemplary embodiment of the present invention, there is provided a method for manufacturing an electrode of an energy storage, the method including: applying first slurry to one surface or both surfaces of a current collector to form a first electrode layer; forming a surface roughness on an outer surface of the first electrode layer; and applying second slurry to the outer surface of the first electrode layer having the surface roughness formed thereon to form a second electrode layer, wherein in each of the first and second electrode layers, content ratios of an active material, a conductive material, and a binder, and materials thereof are different.

### BRIEF DESCRIPTION OF THE DRAWINGS

FIG. 1 is a view schematically showing an electrode of an energy storage according to the related art;

FIG. 2 is a view schematically showing a general winding type energy storage according to the related art;

FIG. 3 is a cross-sectional view schematically showing an electrode of an energy storage according to an exemplary embodiment of the present invention;

FIG. 4 is a cross-sectional view schematically showing an electrode of an energy storage according to another exemplary embodiment of the present invention;

FIG. 5A is a perspective view schematically showing a surface treatment unit according to the exemplary embodiment of the present invention;

FIG. 5B is a bottom view of FIG. 5A;

FIG. 6 is a flow chart schematically showing a method for manufacturing an electrode of an energy storage according to the exemplary embodiment of the present invention; and

FIG. 7 is a flow chart schematically showing a method for manufacturing an electrode of an energy storage according to another exemplary embodiment of the present invention.

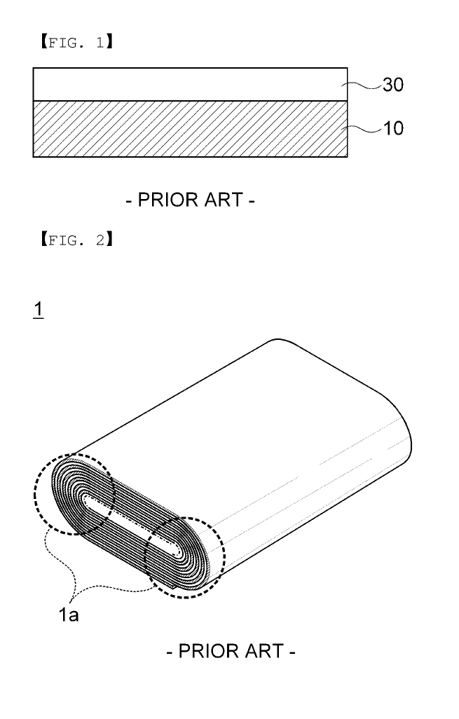

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

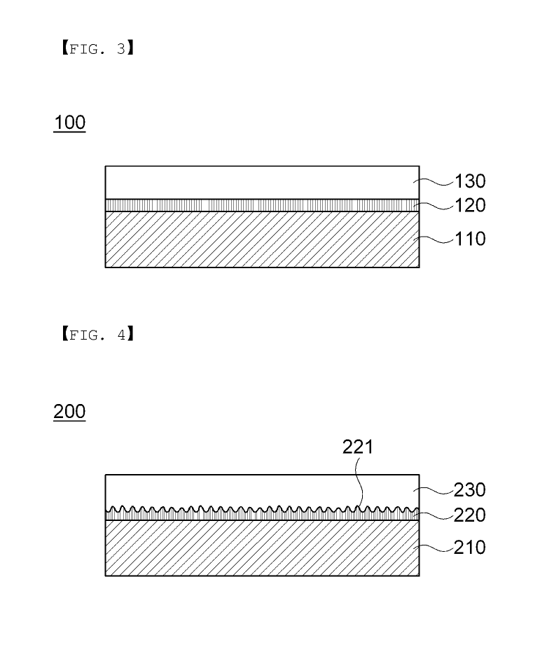

FIG. 3 is a cross-sectional view schematically showing an electrode 100 of an energy storage according to an exemplary embodiment of the present invention.

Referring to FIG. 3, the electrode 100 of the energy storage according to the exemplary embodiment of the present invention may include a current collector 110, a first electrode layer 120, and a second electrode layer 130.

The current collector 110 serves as a conducting wire moving electrons supplied from an active material forming an electrode.

Therefore, when the current collector 110 becomes excessively thin, resistance of the current collector 110 itself increases, and when the current collector 110 becomes thick in excess of a range in which it may sufficiently efficiently move the electrons supplied from the active material, the entire size of the energy storage may unnecessarily increase or a ratio of an electrode material may decrease in the case in which the entire size of the energy storage is limited. Accordingly, the current collector 110 may have a thickness of about 10 to 300 μm.

In addition, the current collector 110 may be made of aluminum, stainless steel, copper, nickel, an alloy thereof, and the like, having relatively light weight and high conductivity.

The first electrode layer 120, which is a layer bonded to one surface or both surfaces of the current collector 110, may contain an active material, a conductive material, and a binder.

In addition, the second electrode layer 130, which is a layer bonded to an outer surface of the first electrode layer 120, may also contain an active material, a conductive material, and a binder.

Meanwhile, a main object of the present invention is to provide improve bonding strength between the current collector 110 and the electrode material. To this end, it is preferable that the first and second electrode layers 120 and 130 are implemented as follows.

First, it is preferable that in each of the first and second electrode layers 120 and 130, content ratios of an active material, a conductive material, and a binder, and/or materials thereof are different.

That is, when it is assumed that each of an active material, a conductive material, and a binder forming the first electrode layer 120 is referred to as a first active material, a first conductive material, and a first binder and each of an active material, a conductive material, and a binder forming the second electrode layer 130 is referred to as a second active material, a second conductive material, and a second binder, it is preferable that the following conditions are satisfied.

Weight Ratio of First Electrode Layer 120—First Conductive Material:First Binder=60:40 to 65:35

Weight Ratio of Second Electrode Layer 130—Second Active Material:Second Conductive Material:Second Binder=88:5.5:6.5

In addition, the second active material may be at least one carbon material selected from a group consisting of activated carbon, carbon nano-tube (CNT), graphite, carbon aerogel, polyacrylonitrile (PAN), carbon nano-fiber (CNF), activated carbon nano-fiber (ACNF), vapor grown carbon fiber (VGCF), and graphene.

In addition, the first and second conductive materials may be at least one material selected from a group consisting of carbon black, acetylene black, CNT, CNF, ketjen black.

In addition, the first binder may be at least one material selected from a group consisting of styrene-butadiene rubber (SBR), butadiene rubber, acrylic rubber, isoprene rubber, carboxylicmethylcellulose (CMC), and polyvinylpyrrolidone (PVP).

In addition, the second binder may be a mixture of at least one material selected from a group consisting of styrene-butadiene rubber (SBR), butadiene rubber, acrylic rubber, isoprene rubber, and carboxylicmethylcellulose (CMC), and at least one material selected from a group consisting of polytetrafluoroethylene (PTFE), polyvinylidenefluoride (PVDF), and polyvinylformamide (PVFA).

Here, PTFE, PVDF, PVFA, and the like, are excellent in linear adhesion that particles are connected to each other in a ring form, such that they may increase bonding force between the active material and the conductive material.

### Experimental Example 1

First Electrode Layer 120—First Conductive Material:CMC:PVP:SBR=55.6:22.2:5.6:16.6

Second Electrode Layer 130—First Active Material:Second Conductive Material:CMC:SBR:PTFE=88:5.5:1.1:3.8:1.6

### Comparative Example

Activated Carbon:Conductive Material:CMC:PVP:SBR:PTFE 80:10:3:0.5:5:1.5

As a result of measuring bonding strengths with respect to electrodes manufactured according to Experimental Example 1 and Comparative Example, bonding strength of an electrode according to Experimental Example 1 was 6.7 N/m and bonding strength of an electrode according to Comparative Example was 4.2 N/m. That is, it was appreciated that the bonding strength of the electrode according to Experimental Example 1 is higher than that of the electrode according to Comparative Example.

After a process of charging a predetermined constant current in electrochemical capacitors each including the electrodes manufactured according to Experimental Example 1 and Comparative Example up to 2.8 V and then discharging the same constant current as the current supplied at the time of charging from the electrochemical capacitors up to 2.0 V is repeatedly performed five times, initial capacitance and resistance were measured.

In addition, after a charging and discharging cycle is conducted only once under a 100 C rate condition (20 A charging and discharging) to perform charging and discharging, capacitance and resistance were again measured. Here, the resistance was measured using an AC meter.

TABLE 1
[Measurement Results of Initial Capacitance and Resistance]

| Division | Initial C (F) | Resistance (mΩ) |
|---|---|---|
| Experimental Example 1 | 14.4 | 9.8 |
| Comparative Example | 16.3 | 13.1 |

TABLE 2
[Measurement Results of Capacitance and Resistance
After Charging and Discharging]

| | Capacitance (F)/ | Resistance (mΩ)/ |
|---|---|---|
| Division | Change Rate (%) | Change Rate (%) |
| Experimental Example 1 | 13.7/−5 | 11.8/+20 |
| Comparative Example | 13.7/−16 | 22.3/+70 |

Referring to Tables 1 and 2, it could be appreciated that in the case of Experimental Example 1 according to the exemplary embodiment of the present invention, a decrease rate in capacitance and an increase rate in resistance were low as compared to the case of Comparative Example.

FIG. 4 is a cross-sectional view schematically showing an electrode 200 of an energy storage according to another exemplary embodiment of the present invention. Meanwhile, a description of contents overlapped with the above-mentioned contents will be omitted.

Referring to FIG. 4, in the electrode 200 of the energy storage according to another exemplary embodiment of the present invention, a surface roughness is formed on an outer surface of a first electrode layer 220, and a second electrode layer 230 is bonded to a surface of the first electrode layer 220 on which the surface roughness is formed.

A main object of the present invention is to improve bonding strength between a current collector 210 and an electrode material. Bonding strength between the first and second electrode layers 220 and 230 may be improved by the surface roughness of the first electrode layer 220.

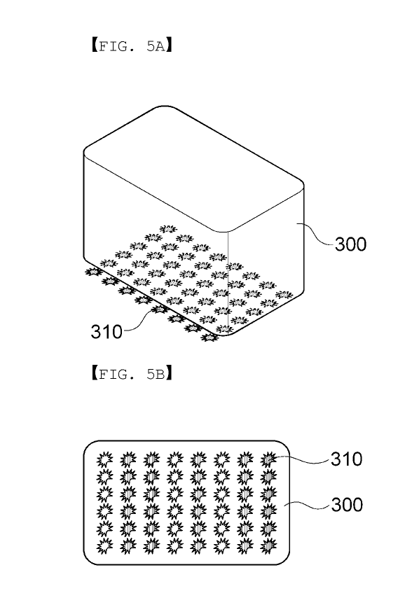

FIG. 5A is a perspective view schematically showing a surface treatment unit 300 according to the exemplary embodiment of the present invention; and FIG. 5B is a bottom view of FIG. 5A.

Referring to FIGS. 5A and 5B, the surface treatment unit 300 may include a fine concave-convex part 310 formed on at least one surface thereof. The first electrode layer 220 is pressed using this surface treatment unit 300, thereby making it possible to form the surface roughness of the outer surface of the first electrode layer 220.

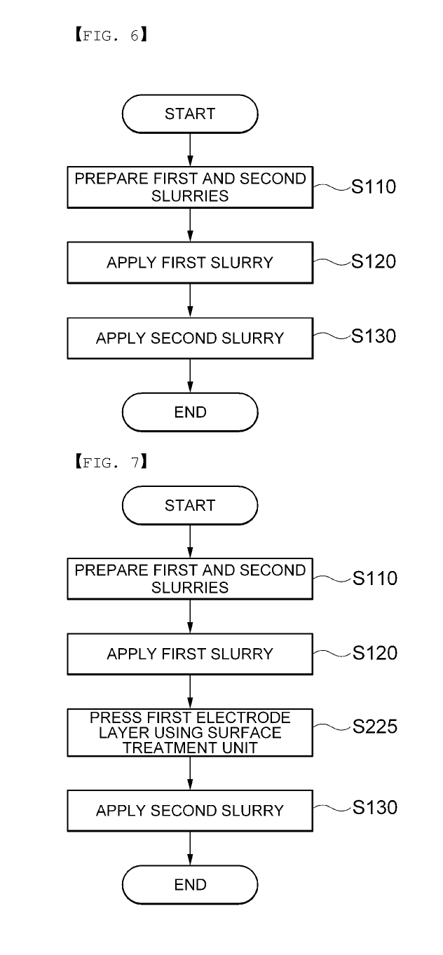

FIG. 6 is a flow chart schematically showing a method for manufacturing an electrode 100 of an energy storage according to the exemplary embodiment of the present invention.

Referring to FIG. 6, first slurry for forming a first electrode layer 120 and second slurry for forming a second electrode layer 130 are first prepared (S110).

Then, the first slurry is applied to a surface of a current collector 110 to form the first electrode layer 120 (S120).

Next, the second slurry is applied to an outer surface of the first electrode layer 120 (S130).

Here, the first and second electrode layers 120 and 130e are formed so as to satisfy the above-mentioned condition, such that a bonding property therebetween may be improved.

FIG. 7 is a flow chart schematically showing a method for manufacturing an electrode 200 of an energy storage according to another exemplary embodiment of the present invention.

Referring to FIG. 7, first slurry for forming a first electrode layer 220 and second slurry for forming a second electrode layer 230 are first prepared (S110).

Then, the first slurry is applied to a surface of a current collector 210 to form the first electrode layer 220 (S120).

Next, a surface roughness 221 is formed on an outer surface of the first electrode layer 220 (S225). Here, the surface roughness 221 may be formed by pressing the first electrode layer 220 using the surface treatment unit 300 as shown in FIGS. 5A and 5B.

Next, the second slurry is applied to an outer surface of the first electrode layer 220 (S130).

Here, the first and second electrode layers 220 and 130e are formed so as to satisfy the above-mentioned condition, such that a bonding property therebetween may be improved.

According to the exemplary embodiments of the present invention configured as described above, the bonding force between the current collector and the first and second electrode layers is improved as compared to the case according to the related art, such that a delamination phenomenon, or the like, generated on an interface between heterogeneous materials is reduced, thereby making it possible to increase reliability and decrease resistance.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An electrode of an energy storage, the electrode comprising:
a current collector;
a first electrode layer provided on one surface or both surfaces of the current collector; and
a second electrode layer bonded to an outer surface of the first electrode layer,
wherein in each of the first and second electrode layers, content ratios of an active material, a conductive material, and a binder, or materials thereof are different.

2. An electrode of an energy storage, the electrode comprising:
a current collector;
a first electrode layer provided on one surface or both surfaces of the current collector; and
a second electrode layer bonded to an outer surface of the first electrode layer,
wherein in each of the first and second electrode layers, content ratios of an active material, a conductive material, and a binder, and materials thereof are different.

3. The electrode according to claim 1, wherein the first electrode layer contains:
a first conductive material, which is at least one material selected from a group consisting of carbon black, acetylene black, CNT, CNF, ketjen black, and
a first binder, which is at least one material selected from a group consisting of styrene-butadiene rubber (SBR), butadiene rubber, acrylic rubber, isoprene rubber, carboxylicmethylcellulose (CMC), and polyvinylpyrrolidone (PVP), and
wherein the second electrode layer contains:
a second active material, which is at least one carbon material selected from a group consisting of activated carbon, carbon nano-tube (CNT), graphite, carbon aerogel, polyacrylonitrile (PAN), carbon nano-fiber (CNF), activated carbon nano-fiber (ACNF), vapor grown carbon fiber (VGCF), and graphene,
a second conductive material, which is at least one material selected from a group consisting of carbon black, acetylene black, CNT, CNF, ketjen black, and
a second binder, which is at least one mixture of at least one material selected from a group consisting of styrene-butadiene rubber (SBR), butadiene rubber, acrylic rubber, isoprene rubber, and carboxylicmethylcellulose (CMC), and at least one material selected from a group consisting of polytetrafluoroethylene (PTFE), polyvinylidenefluoride (PVDF), and polyvinylformamide (PVFA).

4. The electrode according to claim 3, wherein in the first electrode layer, a weight ratio of the first conductive material to the first binder is 60:40 to 65:35, and
in the second electrode layer, a weight ratio of the second active material to the second conductive material to the second binder is 88:5.5:6.5.

5. The electrode according to claim 2, wherein in the first electrode layer, a weight ratio of a first conductive material to a first binder is 60:40 to 65:35, and
in the second electrode layer, a weight ratio of a second active material to a second conductive material to a second binder is 88:5.5:6.5.

6. An electrode of an energy storage, the electrode comprising:
a current collector;
a first electrode layer provided on one surface or both surfaces of the current collector and having a surface roughness formed on an outer surface thereof; and
a second electrode layer bonded to the outer surface of the first electrode layer having the surface roughness formed thereon,
wherein in each of the first and second electrode layers, content ratios of an active material, a conductive material, and a binder, and materials thereof are different.

7. The electrode according to claim 6, wherein the first electrode layer contains:
a first conductive material, which is at least one material selected from a group consisting of carbon black, acetylene black, CNT, CNF, ketjen black, and
a first binder, which is at least one material selected from a group consisting of styrene-butadiene rubber (SBR), butadiene rubber, acrylic rubber, isoprene rubber, carboxylicmethylcellulose (CMC), and polyvinylpyrrolidone (PVP), and
wherein the second electrode layer contains:
a second active material, which is at least one carbon material selected from a group consisting of activated carbon, carbon nano-tube (CNT), graphite, carbon aerogel, polyacrylonitrile (PAN), carbon nano-fiber (CNF), activated carbon nano-fiber (ACNF), vapor grown carbon fiber (VGCF), and graphene,
a second conductive material, which is at least one material selected from a group consisting of carbon black, acetylene black, CNT, CNF, ketjen black, and
a second binder, which is at least one mixture of at least one material selected from a group consisting of styrene-butadiene rubber (SBR), butadiene rubber, acrylic rubber, isoprene rubber, and carboxylicmethylcellulose (CMC), and at least one material selected from a group consisting of polytetrafluoroethylene (PTFE), polyvinylidenefluoride (PVDF), and polyvinylformamide (PVFA).

8. The electrode according to claim 7, wherein in the first electrode layer, a weight ratio of the first conductive material to the first binder is 60:40 to 65:35, and
in the second electrode layer, a weight ratio of the second active material to the second conductive material to the second binder is 88:5.5:6.5.

9. The electrode according to claim 6, wherein in the first electrode layer, a weight ratio of a first conductive material to a first binder is 60:40 to 65:35, and
in the second electrode layer, a weight ratio of a second active material to a second conductive material to a second binder is 88:5.5:6.5.

10. A method for manufacturing an electrode of an energy storage, the method comprising:
applying first slurry to one surface or both surfaces of a current collector to form a first electrode layer; and
applying second slurry to an outer surface of the first electrode layer to form a second electrode layer,
wherein in each of the first and second electrode layers, content ratios of an active material, a conductive material, and a binder, and materials thereof are different.

11. The method according to claim 10, wherein the first slurry contains:
a first conductive material, which is at least one material selected from a group consisting of carbon black, acetylene black, CNT, CNF, ketjen black, and
a first binder, which is at least one material selected from a group consisting of styrene-butadiene rubber (SBR), butadiene rubber, acrylic rubber, isoprene rubber, carboxylicmethylcellulose (CMC), and polyvinylpyrrolidone (PVP), and
wherein the second slurry contains:
a second active material, which is at least one carbon material selected from a group consisting of activated carbon, carbon nano-tube (CNT), graphite, carbon aerogel, polyacrylonitrile (PAN), carbon nano-fiber (CNF), activated carbon nano-fiber (ACNF), vapor grown carbon fiber (VGCF), and graphene,
a second conductive material, which is at least one material selected from a group consisting of carbon black, acetylene black, CNT, CNF, ketjen black, and
a second binder, which is at least one mixture of at least one material selected from a group consisting of styrene-butadiene rubber (SBR), butadiene rubber, acrylic rubber, isoprene rubber, and carboxylicmethylcellulose (CMC), and at least one material selected from a group consisting of polytetrafluoroethylene (PTFE), polyvinylidenefluoride (PVDF), and polyvinylformamide (PVFA).

12. The method according to claim 11, wherein in the first slurry, a weight ratio of the first conductive material to the first binder is 60:40 to 65:35, and
in the second slurry, a weight ratio of the second active material to the second conductive material to the second binder is 88:5.5:6.5.

13. The method according to claim 10, wherein in the first slurry, a weight ratio of a first conductive material to a first binder is 60:40 to 65:35, and
in the second slurry, a weight ratio of a second active material to a second conductive material to a second binder is 88:5.5:6.5.

14. A method for manufacturing an electrode of an energy storage, the method comprising:
applying first slurry to one surface or both surfaces of a current collector to form a first electrode layer;
forming a surface roughness on an outer surface of the first electrode layer; and
applying second slurry to the outer surface of the first electrode layer having the surface roughness formed thereon to form a second electrode layer,
wherein in each of the first and second electrode layers, content ratios of an active material, a conductive material, and a binder, and materials thereof are different.

15. The method according to claim 14, wherein the first slurry contains:
a first conductive material, which is at least one material selected from a group consisting of carbon black, acetylene black, CNT, CNF, ketjen black, and
a first binder, which is at least one material selected from a group consisting of styrene-butadiene rubber (SBR), butadiene rubber, acrylic rubber, isoprene rubber, carboxylicmethylcellulose (CMC), and polyvinylpyrrolidone (PVP), and
wherein the second slurry contains:
a second active material, which is at least one carbon material selected from a group consisting of activated carbon, carbon nano-tube (CNT), graphite, carbon aerogel, polyacrylonitrile (PAN), carbon nano-fiber (CNF), activated carbon nano-fiber (ACNF), vapor grown carbon fiber (VGCF), and graphene,
a second conductive material, which is at least one material selected from a group consisting of carbon black, acetylene black, CNT, CNF, ketjen black, and
a second binder, which is at least one mixture of at least one material selected from a group consisting of styrene-butadiene rubber (SBR), butadiene rubber, acrylic rubber, isoprene rubber, and carboxylicmethylcellulose (CMC), and at least one material selected from a group consisting of polytetrafluoroethylene (PTFE), polyvinylidenefluoride (PVDF), and polyvinylformamide (PVFA).

16. The method according to claim 15, wherein in the first slurry, a weight ratio of the first conductive material to the first binder is 60:40 to 65:35, and
in the second slurry, a weight ratio of the second active material to the second conductive material to the second binder is 88:5.5:6.5.

17. The method according to claim 14, wherein in the first slurry, a weight ratio of a first conductive material to a first binder is 60:40 to 65:35, and
in the second slurry, a weight ratio of a second active material to a second conductive material to a second binder is 88:5.5:6.5.
